(19) United States
(12) Patent Application Publication
(10) Pub. No.: US 2023/0325892 A1
(43) Pub. Date: Oct. 12, 2023

(54) SYSTEM AND METHOD FOR MANAGING LICENSE OF SOFTWARE

(71) Applicant: Hitachi, Ltd., Tokyo (JP)

(72) Inventors: Yoshitake TSUCHIYA, Tokyo (JP); Akira MATSUI, Tokyo (JP)

(21) Appl. No.: 18/105,209

(22) Filed: Feb. 2, 2023

(30) Foreign Application Priority Data
Apr. 8, 2022 (JP) 2022-064453

(51) Int. Cl. G06Q 30/0283; G06Q 40/12

(52) U.S. Cl. CPC G06Q 30/0284; G06Q 40/12

(57) ABSTRACT

A system calculates, for each point in time, an actual license fee at the point in time on the basis of management information, calculates a predicted license fee at the time of the end of a budget management period on the basis of a time series of the actual license fee, calculates a software use situation in which the predicted license fee is within a budget in a case in which the predicted license fee exceeds the budget, and performs control including stopping a certain piece of software of a certain server. The management information includes information indicating, for each piece of software, a license type, a license purchase unit by type, a fixed license fee regardless of a license period, a license fee per period unit of the license period, and a period unit of the license period.

### BACKGROUND

The present invention generally relates to a computer technology for managing a license of software.

In software license management, a used license quantity (for example, the number of licenses) is compared with a possessed license quantity on a regular basis to determine whether there is excess or deficiency in the number of possessed licenses. When there is an excess or deficiency in the possessed license quantity, at least one of the possessed license quantity and the used license quantity is adjusted.

PTL 1 does not disclose a license, but Patent Document 1 does disclose a technology for optimizing allocation of a calculation resource quantity on a cost basis. PTL 2 discloses a technology for determining a license patch on the basis of a resource use situation.

### CITATION LIST

### Patent Literature

[PTL 1] JP 2021-60745
[PTL 2] WO 2008/146408

### SUMMARY

License management of software is not easy. As a reason therefor, for example, the following may be considered.
There is a case in which a license management unit is a plurality of pieces of software. In this case, the software itself may be different, or the software may be the same but a type of server that executes the software may be different.
A license fee of software may include a cost (for example, an initial cost) that does not result in cost savings even when the software stops.

Even when technologies of PTL 1 and PTL 2 are used, it is difficult to appropriately manage software licenses.

A license management system has been constructed. The license management system receives, for a license management unit (one or a plurality of pieces of software present in one or a plurality of servers and licensed), an input of a budget serving as a threshold value of a license fee, and a budget management period serving as a period in which the budget is applied, and registers the received budget and budget management period. The license management system collects information on the one or each of the plurality of pieces of software. The license management system calculates, for each point in time, an actual license fee at the point in time on the basis of management information including information collected for the one or each of the plurality of pieces of software, calculates a predicted license fee at the time of the end of the budget management period on the basis of a time series of the actual license fee, and calculates an optimal software use situation in a case in which the calculated predicted license fee exceeds the budget. The license management system performs software situation control (control regarding the one or plurality of pieces of software) for bringing a software use situation to the optimal software use situation.

The management information includes information indicating whether a certain piece of software is present in one or more certain servers, and type management information (information indicating, for each piece of software, a license type, a license purchase unit by type, a fixed license fee regardless of a license period, a license fee per period unit of the license period, and a period unit of the license period).

For each point in time, the following is given.
The calculated actual license fee is a cumulative value of an actual license fee total up to the point in time.
The actual license fee total is a total at the point in time of the license fee calculated for each piece of software on the basis of the management information.

The optimal software use situation is a software use situation in which the predicted license fee is within the budget.

The calculation of the optimal software use situation includes a determination as to which software of a certain one of the servers is set to a stop target.

The first software situation control includes stopping the software in the server.

According to the present invention, it is possible to provide appropriate software license management.

### BRIEF DESCRIPTION OF THE DRAWINGS

FIG. 1 illustrates a configuration of an entire system including a license management server according to an embodiment;

FIG. 2 illustrates a configuration of a priority management table;

FIG. 3 illustrates a configuration of a budget management table;

FIG. 4 illustrates a configuration of a server management table;

FIG. 5 illustrates a configuration of a software management table;

FIG. 6 illustrates a configuration of an allocation management table;

FIG. 7 illustrates a configuration of a type management table;

FIG. 8 illustrates a configuration of a cost management table;

FIG. 9 illustrates a flow of prediction processing;

FIG. 10 illustrates a flow of budget excess handling processing;

FIG. 11 illustrates a flow of stop candidate determination processing;

FIG. 12 schematically illustrates an example of a graph of budget excess and budget excess handling;

FIG. 13 illustrates an example of a license management graphical user interface (GUI); and

FIG. 14 schematically illustrates an example of table update in handling budget excess.

### DESCRIPTION OF EMBODIMENTS

In the following description, an “interface apparatus” may be one or more interface devices. The one or more interface devices may be at least one of the following:
One or more input/output (I/O) interface devices. The input/output (I/O) interface device is an interface device for at least one of an I/O device and a remote display computer. The I/O interface device for the display computer may be a communication interface device. The at least one I/O device may be any one of a user interface device such as an input device such as a keyboard and pointing device, and an output device such as a display device.
One or more communication interface devices. The one or more communication interface devices may be one or more communication interface devices of the same type (for example, one or more network interface cards (NICs)) or may be two or more communication interface devices of different types (for example, an NIC and a host bus adapter (HBA)).

Further, in the following description, a “memory” is one or more memory devices that are examples of one or more storage devices, and may typically be a main storage device. At least one memory device in the memory may be a volatile memory device or may be a non-volatile memory device.

Further, in the following description, a “permanent storage apparatus” may be one or more permanent storage devices that are examples of one or more storage devices. The permanent storage device may typically be a non-volatile storage device (for example, an auxiliary storage device) and may be, specifically, a hard disk drive (HDD), a solid state drive (SSD), a non-volatile memory express (NVME) drive (NVME), or a storage class memory (SCM), for example.

Further, in the following description, the “storage apparatus” may be at least a memory and a permanent storage apparatus.

Further, in the following description, a “processor” may be one or more processor devices. At least one processor device may typically be a microprocessor device such as a central processing unit (CPU), but may be another type of processor device such as a graphics processing unit (GPU). The at least one processor device may be single core or may be multi-core. The at least one processor device may be a processor core. The at least one processor device is a processor device in a broad sense, such as a circuit that is a set of gate arrays by hardware description language that performs part or all of processing (for example, a field-programmable gate array (FPGA), a complex programmable logic device (CPLD), or an application specific integrated circuit (ASIC)).

Further, in the following description, a function may be described using an expression of a “yyy unit”, but the function may be realized by one or more computer programs being executed by a processor, may be realized by one or more hardware circuits (for example, an FPGA or ASIC), or may be realized by a combination thereof. When a function is realized by a program being executed by a processor, defined processing is performed while appropriately using a storage apparatus, an interface apparatus, and/or the like, and thus, the function may be at least part of the processor. Processing described with a function as a subject may be processing that is performed by a processor or a device having the processor. The program may be installed from a program source. The program source may be, for example, a program distribution computer or a computer-readable recording medium (for example, a non-transitory recording medium). Description of each function is an example, and a plurality of functions may be combined into one function, or one function may be divided into a plurality of functions.

Further, in the following description, information from which an output is obtained with respect to an input is described using an expression such as an “xxx table”, but the information may be data having any structure (may be structured data or may be unstructured data), or may be a learning model represented by a neural network, a genetic algorithm, or a random forest that generates an output with respect to an input. Therefore, the “xxx table” can be called “xxx information”. Further, in the following description, a configuration of each table is an example, and one table may be divided into two or more tables, or all or some of two or more tables may be one table.

Further, in the following description, common signs among reference signs may be used when description is given without distinguishment of the same type of elements, and reference signs may be used when the same type of elements are distinguished.

Hereinafter, an embodiment of the present invention will be described with reference to the drawings. In the drawings, names of elements are appropriately indicated in a simplified form due to a paper space.

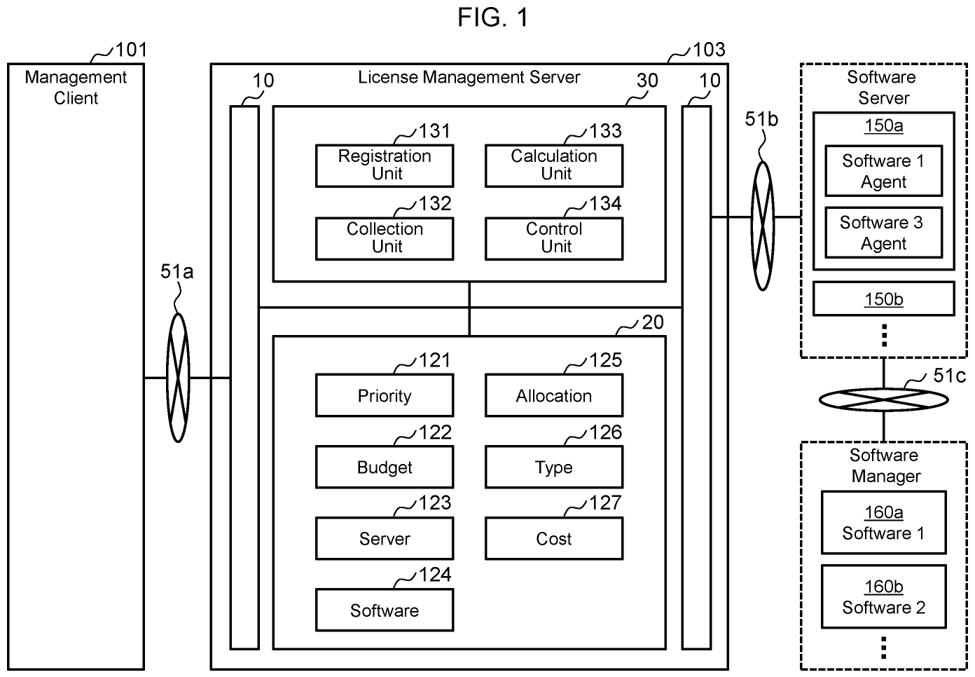

FIG. 1 illustrates a configuration of an entire system including a license management server according to the embodiment.

The license management server 103 communicates with the management client 101 via a communication network 51A. Further, the license management server 103 communicates with software servers 150A, 150B, . . . via a communication network 51B. The software servers 150A, 150B, . . . communicate with software managers 160A, 160B, . . . via a communication network 51C. Each of the communication networks 51A to 51C may be any communication network such as the Internet, a wide area network (WAN), or a local area network (LAN). The communication networks 51A to 51C may be different communication networks, or two or more of the communication networks may be the same communication network.

The management client 101 may be an information processing terminal such as a personal computer or a smart phone. The management client 101 transmits a request to the license management server 103 and receives a response to the request. An operator of the management client 101 is typically a license manager.

The software server 150 executes software and includes a software agent. The software agent receives a request from the software manager 160 and returns information on the software corresponding to the agent to the software manager 160 in response to the request. For example, the software server 150A executes software 1 and 3 and includes an agent for each of pieces of software 1 and 3.

The software manager 160 manages software corresponding to the software manager 160. Management target software of the software manager 160 is executed by one or a plurality of software servers 150. For example, the software manager 160A is a manager of software 1, and software 1 is executed by the software server 150A (and another software server).

The license management server 103 includes an interface apparatus 10, a storage apparatus 20, and a processor 30 coupled to these.

Communication is performed between the management client 101 and the software server 150 via the interface apparatus 10. Specifically, for example, the interface apparatus 10 is connected to the communication networks 51A and 51B.

The storage apparatus 20 stores information input to or output from the processor 30 or computer programs that are executed by the processor 30. Examples of the information stored in the storage apparatus 20 include a priority management table 121, a budget management table 122, a server management table 123, a software management table 124, an allocation management table 125, a type management table 126, and a cost management table 127. At least some of these tables 121 to 127 may be stored in a storage device outside the license management server 103. The software management table 124 is present for each piece of software. Details of these tables 121 to 127 will be described below.

Functions such as a registration unit 131, a collection unit 132, a calculation unit 133, and a control unit 134 are realized by the processor 30 executing the computer program. Details of these functions 131 to 134 will be described below.

Each of the license management server 103, the software server 150, and the software manager 160 may be a physical computer system (one or more physical computers), or may be a logical computer system based on the physical computer system (for example, a virtual computer or cloud computing service). Calculation resources of the software server 150 and the software manager 160 may be present in a common physical computer system or may be present in different physical computer systems. Further, in the present embodiment, calculation resources of the license management server 103 are present in a physical computer system different from the physical computer system having the calculation resources of the software server 150 and the software manager 160, but these calculation resources may be present in the common physical computer system. Specifically, for example, the license management server 103 and the software manager 160 may be realized in a first cloud environment (for example, a first public cloud). The software server 150 may be realized in a second cloud environment (for example, a second public cloud).

In the system illustrated in FIG. 1, for example, the following processing is performed.

The registration unit 131 of the license management server 103 receives an input of a priority of each piece of software belonging to a license management unit from the manager through the management client 101, and registers the input priority in the priority management table 121. The “license management unit” is all pieces of software that are license management targets. The license management unit may be one for each service provided by a license purchaser or may be one for each license purchaser. The “manager” may be the license purchaser or its employee.

The registration unit 131 of the license management server 103 receives an input of the budget from the management client 101 and registers the input budget in the budget management table 122, for a budget management period of the license management unit. The “budget management period” is a period in which the budget is applied. In the present embodiment, the budget includes a normal budget and an upper limit budget. The “normal budget” is a standard budget of which the excess is allowed. The “upper limit budget” is a budget of which the excess is not allowed.

Each software manager 160 collects software situation information of software corresponding to the manager 160 from the one or each of the plurality of software servers 150 having an agent for the software. The “software situation information” is information indicating a situation of the software, and includes, for example, information indicating whether the software is in use or stopped, and information indicating a calculation resource quantity that is used by the software. The collection unit 132 of the license management server 103 collects the software situation information collected by the software manager 160 from each software manager 160 and stores the collected software situation information in the storage apparatus 20. The collection unit 132 may also serve as at least one software manager 160. That is, the collection unit 132 may collect the software situation information from the software server 150 instead of the software manager 160.

The calculation unit 133 of the license management server 103 calculates the predicted license fee at the time of the end of the budget management period of the license management unit. The “predicted license fee” is a predicted future license fee. The predicted license fee may be calculated on the basis of the trend (for example, time series) of an actual license fee of the same license purchaser or a plurality of license purchasers. The “actual license fee” is a cumulative value of an actual total cost. The “actual total cost” is a total of the actual cost of each piece of software. The “actual cost” of each piece of software is a cost calculated on the basis of the software situation information collected for the software.

When there is no excess or deficiency in the budget (the normal budget or the upper limit budget) for the predicted license fee (for example, when the predicted license fee is within the normal budget and a difference between the predicted license fee and the normal budget is equal to or less than a predetermined threshold value), the control unit 134 notifies the software manager 160 of permission to use the license (permission to continue execution of the software) for each piece of software in the license management unit. The software manager 160 that has received the permission notification permits the agent for the software corresponding to the manager to use the license.

On the other hand, when there is the excess or deficiency in the budget for the predicted license fee (for example, the predicted license fee exceeds the upper limit budget, or the predicted license fee is equal to or less the normal budget, but the difference between the predicted license fee and the normal budget exceeds the predetermined threshold value), the calculation unit 133 calculates the optimal software use situation (specifically, a software use situation in which the predicted license fee not causing the excess or deficiency in the budget is expected) on the basis of the priority management table 121, the budget management table 122, the type management table 126, and the cost management table 127. The control unit 134 may transmit a notification indicating the calculated software use situation to the management client 101. The control unit 134 controls a situation of each piece of software according to the calculated software use situation (or the software use situation designated from the manager), and updates the software management table 124 that needs to be updated. The software use situation includes, for each piece of software, presence or absence of the use permission, an allocated calculation resource quantity, and an available period.

The collection of the software situation information or the calculation of the predicted license fee is performed each time a request is received from the manager and/or cyclically.

Hereinafter, the present embodiment will be described in detail.

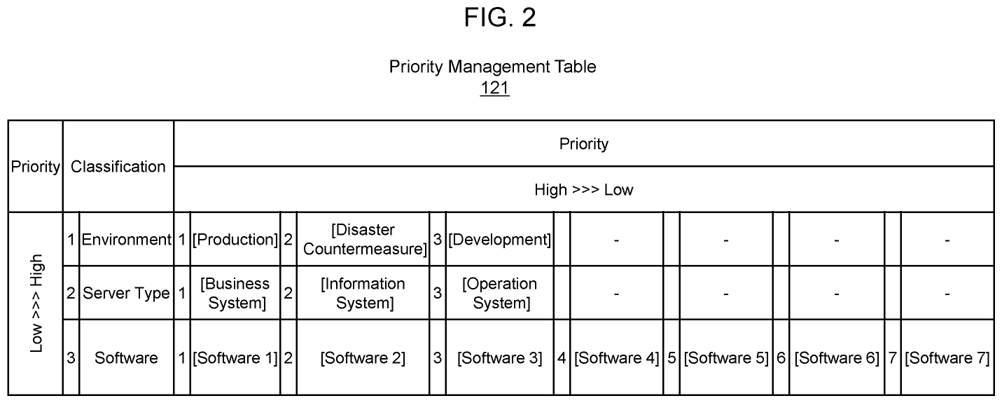

FIG. 2 illustrates a configuration of the priority management table 121.

The priority management table 121 indicates a priority of each classification, and a priority of each classification element belonging to the classification for each classification. According to the example illustrated in FIG. 2, the priority of each classification (and each classification element) is a relative value such as a greater or smaller value than those of the other classifications (other classification elements), but may be an absolute value.

The “classification” is at least software. According to the example illustrated in FIG. 2, the classification elements of the classification “software” are, for example, software 1 to software 7.

The “classification” is an attribute regarding the software server 150 that is an allocation destination of the software, specifically, at least one of a server type and an environment, for example, in addition to the software.

The “server type” is a type of the software server 150. For example, examples of a classification element of the classification “server type” include business system, information system, and operation system.

The “Environment” is an environment to which the software server 150 belongs. For example, examples of a classification element of the classification “environment” include production, disaster countermeasure, and development.

The priority of the software may be determined depending on whether the software is present in a certain software server 150 belonging to a certain environment, in addition to the priority of the software itself. For example, according to FIG. 2, when software 2 is executed on the plurality of software servers 150 with different server types in the same environment (that is, when there are a plurality of pieces of software 2 with different server types), a priority of software 2 differs depending on a priority of the server type and the environment.

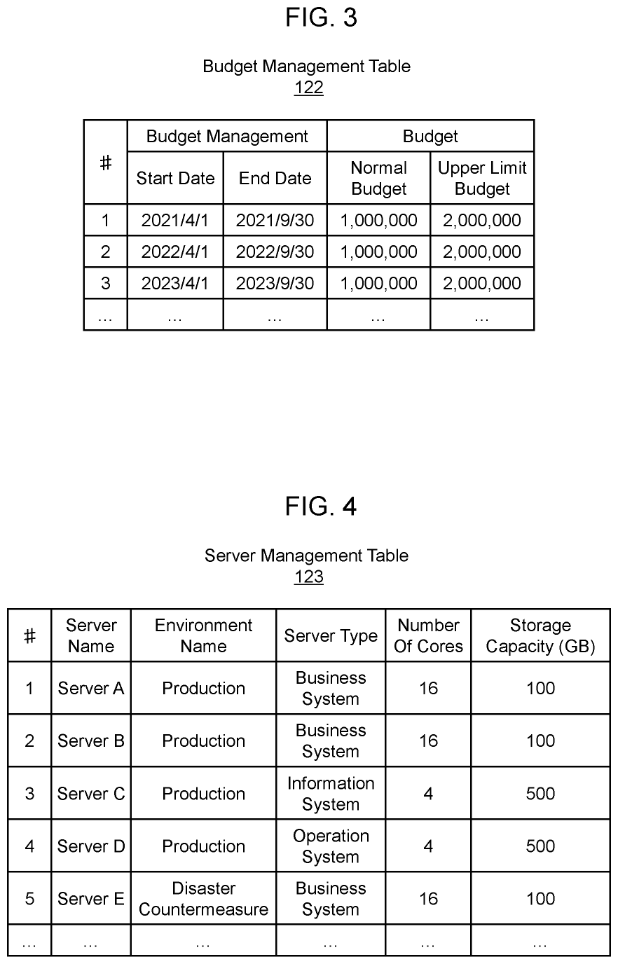

FIG. 3 illustrates a configuration of the budget management table 122.

The budget management table 122 indicates the normal budget and the upper limit budget for each budget management period. The “budget management period” is a period in which the budget is determined, and may be expressed as a set of a start date and an end date as illustrated in FIG. 3 or may be expressed as a set of a reference date (for example, the start date) and a time length from the reference date.

When the predicted license fee exceeds the normal budget (or the upper limit budget), an alert may be issued to the management client 101, or an optimal software use situation in which the predicted license fee is within the normal budget (or the upper limit budget) may be calculated by the calculation unit 133 without issuing the alert.

FIG. 4 illustrates a configuration of the server management table 123.

The server management table 123 indicates the attribute of the software server 150 that can be an allocation destination of the software, and the calculation resources in the license management unit. For example, the server management table 123 indicates, for each software server 150, a server name (a name of the software server 150), an environment name (a name of the environment of the software server 150), a server type (a server type of the software server 150), the number of cores (the number of processor cores provided by the software server 150), and a storage capacity (a storage capacity provided by the software server 150).

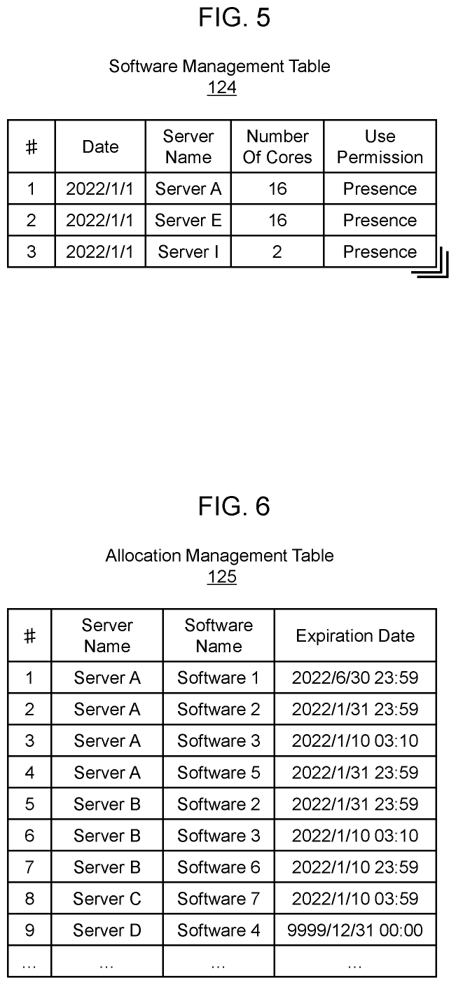

FIG. 5 illustrates a configuration of the software management table 124.

The software management table 124 is present in each piece of software as described above, and indicates a date (a start date of use permission “presence” or “absence”), a server name (the name of the software server 150 that is an allocation destination of the software), the number of cores (the number of processor cores used by the software), and use permission (whether or not use of the software is permitted) for the software. The use permission “presence” means that the use of the software is permitted. The use permission “absence” means that the use of the software is not permitted (that is, stop of the software).

For example, the software management table 124 may be configured as a table common to the plurality of pieces of software by using a method such as having a column of the software name.

FIG. 6 illustrates a configuration of the allocation management table 125.

The allocation management table 125 indicates whether a certain piece of software is present in one or more certain software servers 150, and a license expiration date of the software. Specifically, for example, the allocation management table 125 stores a server name (the name of the software server 150), a software name (a name of the software), and an expiration date (a time limit on which execution of the software on the software server 150 is permitted), for each set of the software server 150 and the software whose allocation destination is the server 150.

Update of the expiration date is synchronized with the cost confirmation in the cost management table 127. Further, for a perpetual license, a value of the expiration date may be a value indicating forever (for example, a very great value such as “9999/12/31” or a special value such as “−1”).

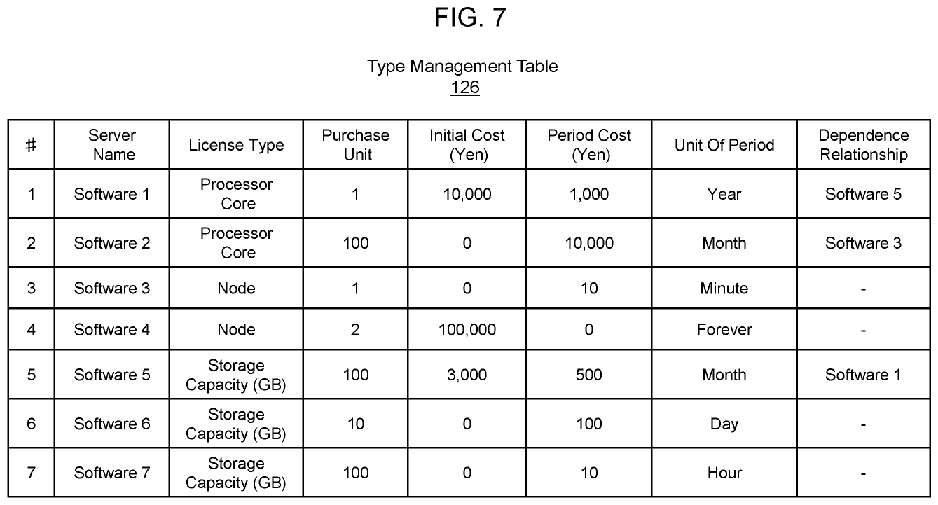

FIG. 7 illustrates a configuration of the type management table 126.

The type management table 126 indicates, for each piece of software, information necessary for calculation of the license fee, and a dependence relationship with another software. Specifically, for example, the type management table 126 indicates, for each piece of software, a license type (a type of billing target), a purchase unit (a license purchase unit by set type), an initial cost (an example of a fixed license fee regardless of the license period), a period cost (a license fee per period unit of the license period), a period unit (a period unit of the license period), and a dependence relationship (dependence destination software).

A billing target or a billing period unit are managed according to characteristics of the software. Further, when software that is a purchase or stop target includes the dependence destination software, the dependence destination software is also required to be purchased or stopped. Specifically, there are the following examples.

(Example 1) It is assumed that the software is software for monitoring life and death of a node (a node computer in a computer system). A unit price of this software depends on the number of monitoring targets (the number of nodes). Therefore, the license type is “node”, and a value of the purchase unit is the number of nodes. For example, the license type “node” and the purchase unit “2” mean that it is necessary to purchase two nodes.
(Example 2) It is assumed that the software is software for analyzing data. The unit price of this software depends on an amount of data to be analyzed. Therefore, the license type is “storage capacity (GB)”, and a value of the purchase unit is a value of the storage capacity. For example, the license type “storage capacity (GB)” and the purchase unit “100” mean that it is necessary to purchase the storage capacity of 100 GB.
(Example 3) It is assumed that the software is software that performs calculation processing on a server that is a management target. A unit price of this software depends on the number of processor cores that are used. Therefore, the license type is a “processor core”, and a value of the purchase unit is the number of processor cores. For example, the license type “processor core” and the purchase unit “100” mean that it is necessary to purchase 100 processor cores.
(Example 4) For software 2, there is a dependence relationship “software 3”. This means that software 2 depends on software 3, in other words, that software 3 is essential for software 2. Therefore, when software 2 is introduced in the software server 150, introduction of software 3 in the software server 150 is required. When software 2 and software 3 are present in the same software server 150 and software 3 is stopped, stop of software 2 is also required. On the other hand, software 3 has no dependence relationship. Therefore, it is possible to introduce or stop software 3 alone regardless of the presence or absence of software 2.

For each piece of software, a set of the period unit and the period cost corresponds to a cost schedule of the software. For example, when software 2 is in use for four months, the cumulative cost of software 2 is 40,000 (period cost of “10,000”×four months).

Further, for each piece of software, the period cost may be a product of a purchase unit price (price per purchase unit) and the number of purchases (not illustrated), except for a unit of the period “forever”. For example, the period cost “1,000” of software 1 may be a product of the purchase unit price “100” and the number of purchases “10”. The number of purchases “10” means that 10 processor cores with the purchase unit of “1” have been purchased.

This, a cost of each piece of software can be calculated from the type management table 126, but the type management table 126 may be associated with various types of information necessary for cost calculation from the software situation information.

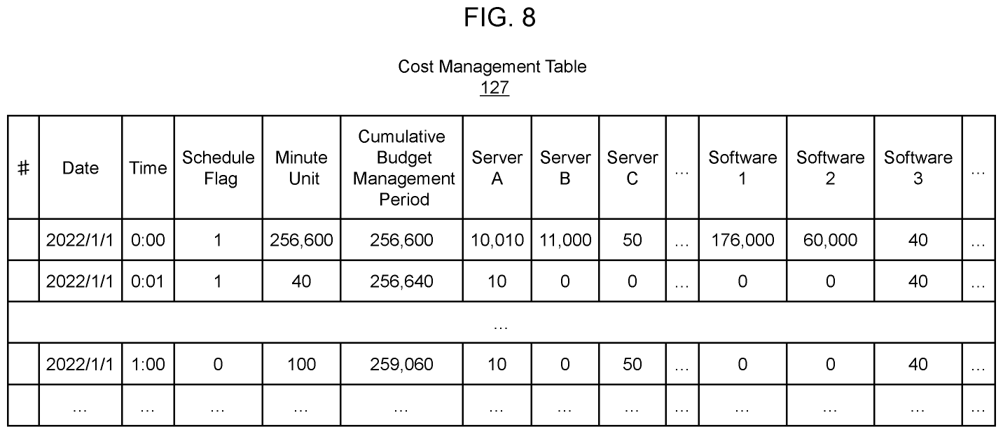

FIG. 8 illustrates a configuration of the cost management table 127.

The cost management table 127 is a table indicating a cost of each classification element at each point in time in the budget management period. The classification element is, for example, the software or the software server 150.

Information indicating s date, a time, a schedule flag, a minute unit, a cumulative budget management period, a cost of each software server, and the cost of each piece of software is stored in a record of each point in time. One record is taken as an example.

The “date” and the “time” are a date and time indicating a point in time.

The “schedule flag” indicates whether the cost is an actual value or a predicted value. “1” means the actual value, and “0” means the predicted value. That is, the number of records in which the schedule flag “0” is updated to “1” increases over time, and a cost in a record after a record with a latest schedule flag “1” is updated by the calculation unit 133 on the basis of an actual cost in the record up to the record of the latest schedule flag “1”.

The “minute unit” means that a cycle of the predicted license fee is a minute, and indicates a total of the cost of each classification element recorded in the record (cost of each classification element for one minute corresponding to the record). When the cycle is year or month, a “year unit” or a “month unit” may be used instead of the “minute unit”.

The “cumulative budget management period” is a cumulative value of a value of the “minute unit” for one minute corresponding to the record and a past value of the “minute unit”. That is, the cumulative budget management period is the actual license fee or the predicted license fee corresponding to the point in time.

For example, every minute, the actual cost of each piece of software is calculated on the basis of the software situation information collected for each software manager 160, and a total of the actual cost is calculated. A cumulative value of the total of the actual costs is the actual license fee.

Further, for example, for each minute, a predicted cost total as an element of the predicted license fee is calculated on an actual prediction basis and/or a license purchaser history basis. For example, this is as follows.
According to the actual prediction basis, a predicted cost of each classification element is calculated for each future point in time on the basis of the assumption that there is no change in the software situation of each piece of software and the time series of the actual cost of each classification element, and a total of the predicted cost is calculated. For each future point in time, the cumulative value of the predicted cost total is the predicted license fee.
According to the license purchaser history basis, the predicted cost of each classification element is calculated on the basis of actual results (time series of the actual cost of each classification element) of the same license purchaser (and/or other license purchasers), and the predicted cost total and the predicted license fee are calculated.

Hereinafter, an example of the processing performed in the present embodiment will be described.

Initial Registration Processing

The registration unit 131 receives the input of the priority from the management client 101. Specifically, the priority of each classification (a priority of each of the software, the software server, and the environment), and the priority of each classification element for each classification are input. The registration unit 131 registers the input priority in the priority management table 121. The input and registration of the priority may be skipped, and the priority of registration may be adopted in the priority management table 121 of default settings.

The registration unit 131 receives the input of the budget and the budget management period (the period in which the budget is applied) for the license management unit from the management client 101. In the present embodiment, the normal budget and the upper limit budget are input as the budgets, and the normal budget, the upper limit budget, and the period are registered in the budget management table 122.

The registration unit 131 receives information on the license purchased by the license purchaser (for example, license type, purchase unit, initial cost, period cost, unit of period, and dependence relationship for each piece of software) from the management client 101, and registers the information in the type management table 126.

Each software manager 160 collects information on the software corresponding to the manager 160 from one or more software agents in one or more software servers 150, and the information is transmitted to the license management server 103. The registration unit 131 receives the collected information from each software manager 160, and constructs the software management table 124 and the allocation management table 125 on the basis of the received information.

A set of server name and software name may be input from the management client 101 and registered in the server management table 123 by the registration unit 131.

Prediction Processing

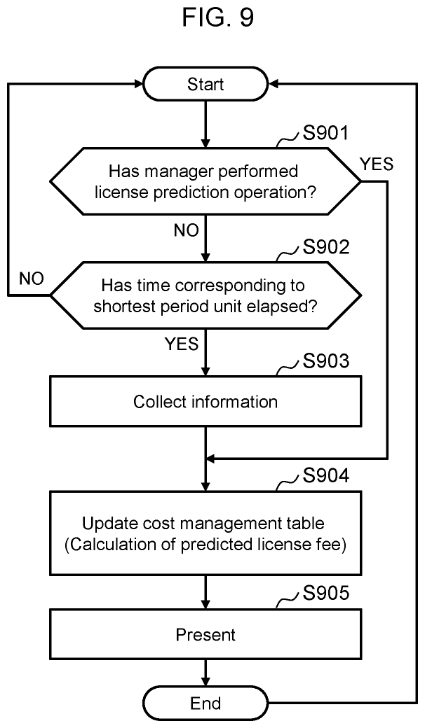

FIG. 9 illustrates a flow of prediction processing.

The calculation unit 133 determines whether or not a license prediction operation has been received from the manager (S901).

When the determination result in S901 is false (S901: Yes), the calculation unit 133 determines whether or not the cycle has elapsed since immediately previous update of the cost management table 127. The “cycle” referred to here is the same as a unit in which a period unit (a period unit registered in the type management table 126) is shortest among one or a plurality of pieces of software in the license management unit (a software group). According to the example illustrated in FIG. 7, the cycle is one minute since “minute” is the shortest unit. Hereinafter, an N-th cycle is referred to as “cycle N” (N is a natural number). N=1 means a first cycle. A current cycle is referred to as a “cycle C” (N=C=natural number).

When a determination result in S901 is true (S901: Yes) or when a determination result in S902 is true (S902: Yes), the collection unit 132 collects from each software manager 160 the information collected from the software agent by the software manager 160, and stores the collected information in the storage apparatus 20 (S903). In S903, for example, the following is performed.
Information indicating, for each piece of software, the software name of the software and the server name of each of all the software servers 150 executing the software is collected. A set of the server name and the software name is registered in the server management table 123 by the registration unit 131.
The expiration date is registered in the allocation management table 125 by the registration unit 131 for each set of server name and software name. The registered expiration date is calculated by the registration unit 131 on the basis of a date of installation indicated by information collected for the software (a date on which the software has been installed in the software server) and a period unit corresponding to the software (a unit of a period specified from the type management table 126). For example, when the unit of the period is “year”, the expiration date is one year after the date of installation. When the unit of the period is “month”, the expiration date is the last day of a month to which the date of installation belongs.

The calculation unit 133 updates the cost management table 127 on the basis of the information collected in S903 (S904). In S904, the predicted license fee is calculated on the basis of the updated cost management table 127. For example, the calculation unit 133 performs the following.
An actual cost of each piece of software and for each software server 150 is registered in a target record (a record corresponding to the cycle C (for example, one minute this time)) in the cost management table 127. For example, for a piece of software, the actual cost is calculated on the basis of a period cost of the software (and the unit of the period) and the cycle. Further, when the cycle C is the first cycle (that is, N=C=1), the actual cost may include the initial cost. Further, for one software server 150, the actual cost may be a total of the actual cost of the one or each of the plurality of pieces of software that is executed by the software server 150.
A total of actual costs of all pieces of software corresponding to the cycle C is calculated. This total is a value as the “minute unit” according to the example of FIG. 8.
A cumulative value of an actual cost total (the value of the “minute unit”) up to the cycle C (the value of the “cumulative budget management period” in the example of FIG. 8) is calculated and registered in the target record. This cumulative value is the actual license fee.
The predicted license fee is calculated according to at least one of the actual prediction basis and the license purchaser history basis. Specifically, for example, the predicted cost of each piece of software from the cycle C to the end of the budget management period is calculated. In the example of FIG. 8, the predicted cost may be a predicted cost every minute from the cycle C to the end of the budget management period. For each minute until the end of the budget management period, the predicted cost total and the predicted license fee (a cumulative value of the predicted cost total) are calculated.

The calculation unit 133 presents information based on the predicted license fee calculated in S904 (for example, the information itself, an e-mail describing a link to the information, or a graphical user interface (GUI) on which the information is displayed) to the manager through the management client 101 (S905).

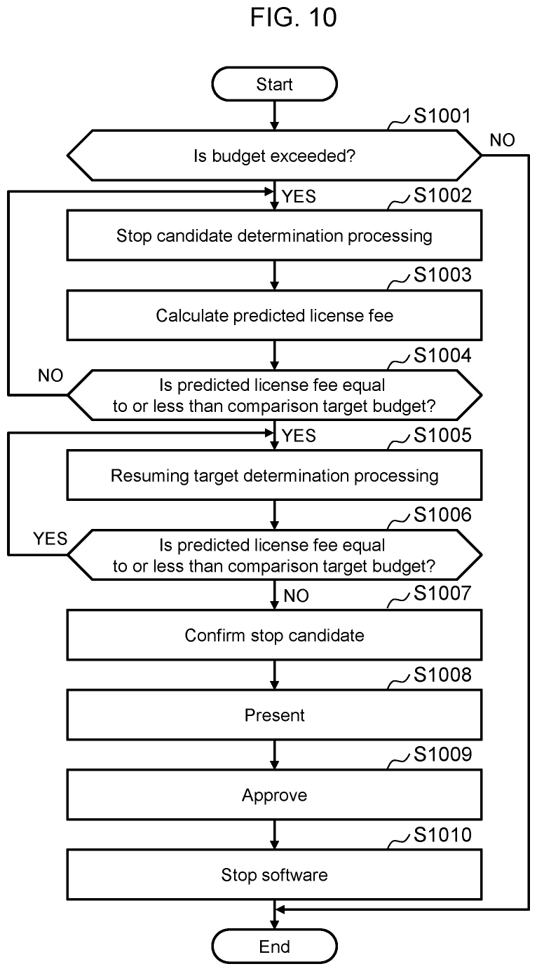

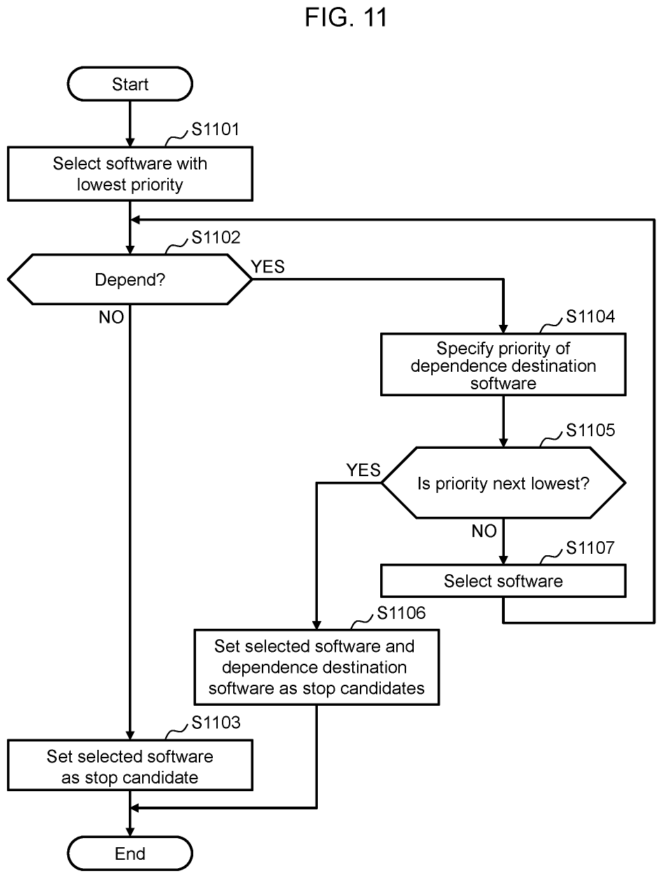

S905 may be skipped and S1001 illustrated in FIG. 10 may be performed. That is, this prediction processing and budget excess handling processing illustrated in FIG. 10 may be examples of the processing.

Budget Excess Handling Processing

FIG. 10 illustrates a flow of the budget excess handling processing.

The calculation unit 133 specifies the budget (the normal budget and the upper limit budget) corresponding to the budget management period from the budget management table 122, and determines whether or not the predicted license fee calculated in S903 exceeds the specified budget (S1001). When the predicted license fee exceeds the budget, a determination result in S1001 is true.

When the determination result in S1001 is true (S1001: Yes), the calculation unit 133 refers to the priority management table 121 to select software that is a stop candidate among the pieces of software that have not been selected in S1002 (the pieces of software with the use permission “presence”) on the basis of the priority and the dependence relationship (S1002). For example, when software 1 is present in the plurality of software servers 150, a plurality of pieces of software 1 are treated as being present. That is, both selected software 1 and unselected software 1 can be present.

The calculation unit 133 calculates the predicted license fee when it is assumed that the software selected in S1002 is stopped for a certain period (S1003). For example, in S1003, the predicted license fee is calculated on the basis of the “certain period”, and a period cost and a period unit of the selected software (the period cost and the period unit indicated by the type management table 126). The “certain period” may be n times (n is a natural number) the period unit of the selected software (the period unit indicated for the software by the type management table 126). Further, a start time and an end time of the “certain period” may be any point in time from a cycle (C+1) next to the cycle C to the end of the budget management period.

The calculation unit 133 determines whether or not the predicted license fee calculated in S1003 is equal to or less than a comparison target budget (S1004). The “comparison target budget” may be the same as the normal budget (or the upper limit budget), or may be a value obtained by multiplying the normal budget (or the upper limit budget) by a predetermined coefficient (a value greater than 0 and smaller than 1). When a determination result in S1004 is false (S1004: NO), the processing returns to S1002.

When the determination result in S1004 is true (S1004: NO), the calculation unit 133 selects the software selected in the last S1002 from among current stop candidate pieces of software (at the point in time of S1005), and calculates a predicted license fee in a case in which the selected software is excluded from the current stop candidate pieces of software (S1005).

The calculation unit 133 determines whether or not the predicted license fee calculated in S1005 is equal to or less than the comparison target budget (S1006). When a result of S1006 is true (S1006: YES), the processing returns to S1005.

When the determination result in S1006 is false (S1006: NO), the calculation unit 133 sets the software selected in the last step S1005 as the stop candidate again, and confirms the stop of all the stop candidate pieces of software (S1007). The calculation unit 133 presents information based on the license fee in a case in which the software confirmed in S1007 has been stopped (for example, the information itself, an e-mail describing a link to the information, or a GUI on which the information is displayed) to the manager through the management client 101 (S1008). The provided information includes information indicating the software confirmed in S1007. In response to the provision of the information in S1008, approval for the stop of the software confirmed in S1007 is received from the management client 101 (S1009), and the control unit 134 stops the software confirmed in S1007 (S1010). S1008 and S1009 may be skipped.

FIG. 11 illustrates a flow of stop candidate determination processing (S1002).

The calculation unit 133 selects software with the lowest priority among unselected pieces of software with the use permission “presence” from the priority management table 121 (S1101). As described above, the priority of the software depends on the priority of the server type and environment of the software, in addition to the priority of the software itself. Further, the “unselected software” referred to here is software that has not been selected in S1002 so far and has not been selected in S1002 as well. In this S1002, the software selected in S1101 or subsequent S1107 is called “selected software” in the description of FIG. 11.

The calculation unit 133 refers to the type management table 126 to determine whether or not there is software having a dependence relationship with the selected software (S1102). When a determination result in S1102 is false (S1102: NO), the calculation unit 133 sets the selected software as the stop candidate (S1103). That is, the software that becomes the stop candidate in S1002 is the selected software.

When the determination result in S1102 is true (S1102: YES), the calculation unit 133 specifies a priority of dependence destination software of the selected software from the priority management table 121 (S1104). The calculation unit 133 determines whether the priority specified in S1104 is the next lowest priority after a priority of the selected software, on the basis of the priority management table 121 (S1105). When there is unselected software with a priority higher than the priority of the selected software but lower than the priority of the dependence destination software, a determination result in S1105 is false. On the other hand, when there is no unselected software with the priority higher than the priority of the selected software but lower than the priority of the dependence destination software, the determination result in S1105 is true.

When the determination result in S1105 is true (S1105: YES), the calculation unit 133 sets the selected software and the dependence destination software as the stop candidates (S1106). That is, the pieces of software that become the stop candidate in S1002 are the selected software and the dependence destination software.

When the determination result in S1105 is false (S1105: NO), the calculation unit 133 selects the unselected software with the priority higher than the priority of the selected software but lower than the priority of the dependence destination software (S1107). Thereafter, the processing returns to S1102.

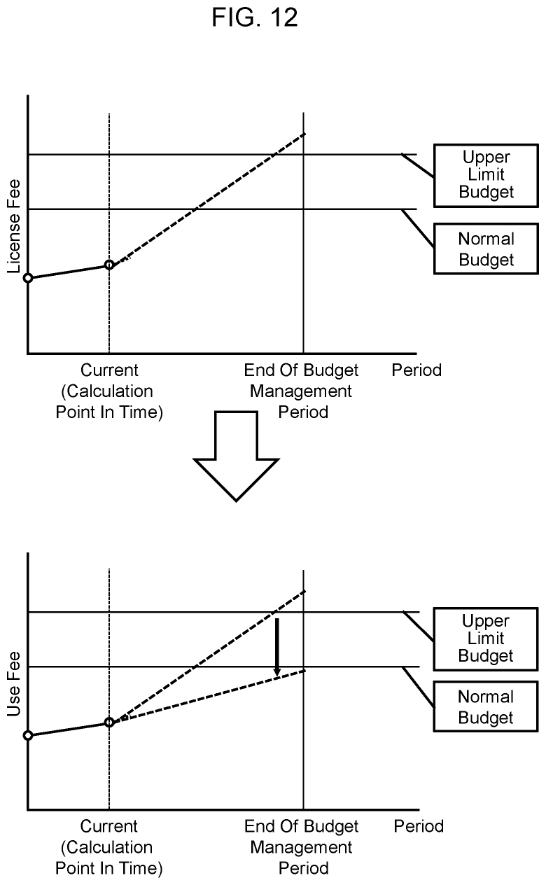

According to the above embodiment, as illustrated in FIG. 12, when a determination result indicating that the predicted license fee exceeds the upper limit budget has been obtained, the optimal software use situation in which the predicted license fee is within the normal budget is calculated.

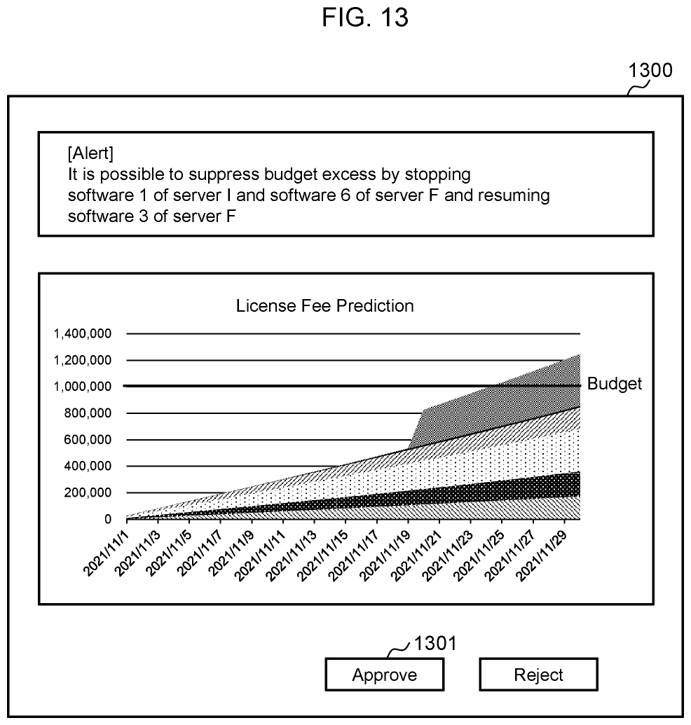

Further, when the determination result indicating that the predicted license fee exceeds the upper limit budget has been obtained, the calculation unit 133 can provide a license management GUI 1300 illustrated in FIG. 13. The license management GUI 1300 displays information indicating an alert indicating that the predicted license fee exceeds the budget (for example, the upper limit budget) by the end of the budget management period, a time series of the actual license fee and the predicted license fee, and a measure for setting the software use situation in which the predicted license fee is within the budget (for example, the normal budget).

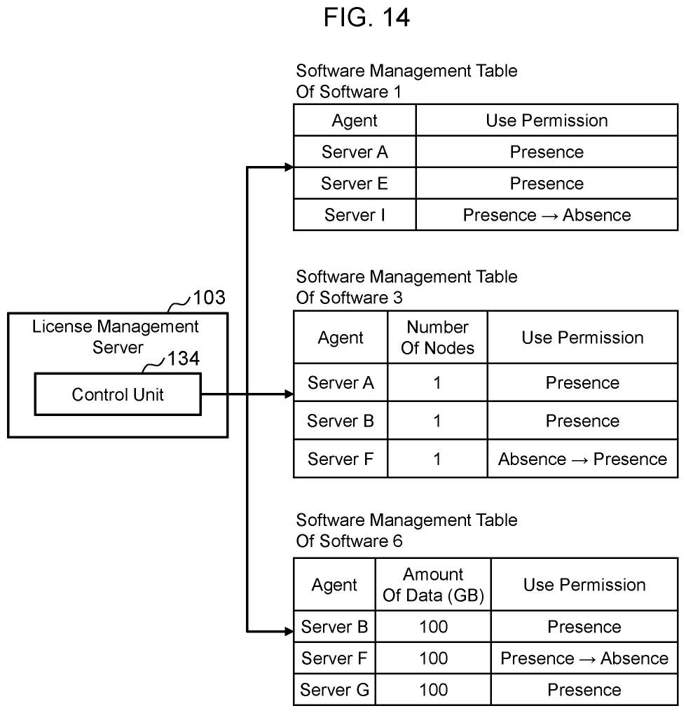

The software use situation in which the predicted license fee is within the budget, that is, the optimal software use situation includes use and stop for each piece of software. According to an example illustrated in FIG. 14, the control unit 134 performs the following to optimize the software use situation.
The “use permission” of software 1 of a software server I is updated to “absence” (that is, stop). Further, an instruction to stop software 1 in the software server I is transmitted to the software server I or the software manager 160A.
The “use permission” of software 3 of the software server F is updated to “presence” (that is, an executable state (stop release state)). Further, an instruction to release the stop of software 3 (to operate software 3) in the software server F is transmitted to the software server F or the software manager 160 of software 3.
The “use permission” of software 6 of the server F is updated to “absence”. Further, an instruction to stop software 6 in the software server F is transmitted to the software server F or the software manager 160 of the software 6.

The above description can be summarized, for example, as follows. The following summary may include description of supplements or variation examples of the above description.

The license management server 103 (an example of a license management system) includes a registration unit 131, a collection unit 132, a calculation unit 133, and a control unit 134.

The registration unit 131 receives, for the license management unit (the one or plurality of pieces of software present in one or a plurality of servers 150 and licensed), an input of a budget and a budget management period (a period in which the budget is applied), and registers the received budget and budget management period in the budget management table 122.

The collection unit 132 collects information on the one or each of the plurality of pieces of software.

The calculation unit 133 calculates, for each point in time, an actual license fee at the point in time on the basis of management information including information collected for the one or each of the plurality of pieces of software, calculates a predicted license fee at the time of the end of the budget management period on the basis of the time series of the actual license fee, and calculates a first optimal software use situation in a case in which the calculated predicted license fee exceeds the budget. The management information includes the allocation management table 125 and the type management table 126. For each point in time, the actual license fee is a cumulative value of an actual license fee total up to the point in time, and the actual license fee total is a total at the point in time of the license fee (actual cost) calculated for each piece of software on the basis of the management information. The first optimal software use situation is a software use situation in which the predicted license fee is within the budget. Calculation of the first optimal software use situation includes a determination as to which software of a certain one of the servers 150 is set as the stop target.

The control unit 134 performs first software situation control, which is control regarding the one or plurality of pieces of software for bringing the software use situation to the first optimal software use situation. The first software situation control includes stopping the software in the server 150 (for example, issuing an instruction to stop the software to the software manager 160 of the stop target or to the server 150 having the software that is the stop target).

Types of license quantities include various types such as the number of licenses and a calculation resource quantity, but it is important to manage various types of license quantities in a unified manner with the license fee, and to manage the license from the viewpoint of cost for the license purchaser. Further, examples of problem unique to the software license management include a problem that software itself may be different or the software is the same, but types of servers 150 executing the software may be different in a case in which the license management unit is a plurality of pieces of software, and a problem that the license fee of the software may include a cost (for example, an initial cost) that do not result in cost savings even when the software stops. With the license management server 103, it is possible to solve these problems and provide appropriate software license management.

The management information may include the priority management table 121, which is information indicating the priority of each classification element belonging to one or each of a plurality of classifications for the one or each of the plurality of classifications. The one or plurality of classifications may include a classification such as software. The priority of each classification element belonging to the classification may be a priority of the software itself. The calculation unit 133 may determine which software of a certain one of the servers 150 is set as a stop target, on the basis of the priority management table 121. This makes it possible to expect avoidance of both the stop of software with a high priority and the budget excess.

The plurality of classifications may include at least one of a server type of the server 150 in which there is software and an environment in which there is software. The calculation unit 133 may determine a priority of the software on the basis of a priority of the software itself and a priority of at least one of the server type of the server in which there is the software and the environment in which there is the software. This makes it possible to expect that the software serving as the stop target is appropriately selected in order to avoid budget excess.

The calculation unit 133 may perform the following processing (a) to (e). This makes it possible to expect both preferentially setting software with a low priority as the stop target and not stopping the software as much as possible within a range of the budget. The “certain period” below may vary depending on the software, and may be, for example, n times the period unit of the software (n is a natural number).
(a) selecting the software with the lowest priority from among the unselected software subjected to stop release, and setting the selected software as a stop candidate;
(b) calculating a predicted license fee in a case in which all the stop candidate pieces of software are stopped during a certain period, and determining whether the predicted license fee is equal to or less than a comparison target budget equal to or less than the budget;
(c) performing (a) when a determination result of (b) is false;
(d) excluding the most pieces of software from the stop candidates in a range in which the predicted license fee is equal to or less than the comparison target budget when the determination result of (b) is true; and
(e) determining all the stop candidate pieces of software after (d) are determined as stop targets.

The calculation unit 133 may perform the following (a1) to (a3) in (a). This makes it possible to determine the stop target according to a software dependence relationship, specifically, stop only one of pieces of software having the dependence relationship, thereby avoiding the other software unnecessarily consuming resources and causing a license fee.
(a1) selecting software with the lowest priority from among unselected pieces of software subjected to stop release;
(a2) setting the selected software as the stop candidate when there is no dependence destination software of the selected software; and
(a3) setting the selected software and the dependence destination software as stop candidates when there is the dependence destination software of the selected software.

In (a3), when the priority of the dependence destination software is the next lowest priority after the priority of the selected software, the calculation unit 133 may set the selected software and the dependence destination software as stop candidates. On the other hand, when there is software with a priority lower than the priority of the dependence destination software, the calculation unit 133 may select the software and perform (a2). This makes it possible to achieve both setting all pieces of software having the dependence relationship as the stop targets and preferentially setting the software having a low priority as the stop target.

The calculation unit 133 may periodically perform calculation of the predicted license fee. The cycle of the calculation may have the same length as the shortest period unit among period units of the plurality of pieces of software. This makes it possible to solve problems unique to the license management, such as different period units of the plurality of pieces of software, and to efficiently and accurately avoid budget excess of the license management unit.

The calculation unit 133 may present the first optimal software use situation to the manager. The control unit 134 may perform the first software situation control when approval for the presented first optimal software use situation is received from the manager. This makes it possible to avoid software situation control not predicted by the manager.

The calculation unit 133 may calculate the second optimal software use situation in a case in which the calculated predicted license fee is within the budget and a difference between the predicted license fee and the budget is equal to or greater than a certain value (that is, when the budget is sufficient). The control unit 134 may perform second software situation control that is control regarding the one or plurality of pieces of software for bringing the software use situation to the second optimal software use situation. The second optimal software use situation may be a software use situation in which the predicted license fee approaches the budget. The calculation of the second optimal software use situation may include a determination as to whether the stop of a certain piece of software of a certain one of the servers 150 is released. The second software situation control may include stop release of the software in the server 150. Accordingly, it is possible to expect to operate as much software as possible in the license management unit while avoiding the budget excess.

For example, when the predicted license fee calculated in S903 is equal to or less than the normal budget (or the upper limit budget) and the difference between the predicted license fee and the budget is equal to or greater than the certain value, the calculation unit 133 may perform budget surplus handling processing including calculation of the second optimal software use situation. In the description with reference to FIGS. 10 and 11, the budget surplus handling processing can be derived as follows, for example, through conversion from a priority to software with a low priority to a priority to software with a high priority.

That is, the calculation unit 133 refers to the priority management table 121 and performs stop release candidate selection for selecting software that is a stop release candidate (an operation resuming candidate) from among the unselected pieces of software with the use permission “absence” (unselected software in the budget surplus handling processing) on the basis of the priority and the dependence relationship. The calculation unit 133 calculates the predicted license fee in a case in which it is assumed that the stop of the selected software is released during the certain period. The calculation unit 133 determines whether the predicted license fee is within the budget and the difference between the predicted license fee and the budget is smaller than the certain value. When the determination result is false, the calculation unit 133 performs the stop release candidate selection again. When the determination result is true, the calculation unit 133 performs the second software situation control including the stop release of the stop release candidate.

The following processing may be performed in the stop release candidate selection.

That is, the calculation unit 133 selects the software with the highest priority from among the unselected pieces of software with the use permission “absence” from the priority management table 121.

When there is no software having a dependence relationship with the selected software, the calculation unit 133 sets the selected software as the stop release candidate.

When there is software having the dependence relationship with the selected software, and the priority of the dependence destination software is the next highest priority after a priority of the selected software, the calculation unit 133 sets the selected software and the dependence destination software as stop release candidates.

When there is software having a dependence relationship with the selected software, but there is unselected software with a higher priority than the priority of the dependence destination software, the unselected software is selected and similar processing according to whether or not there is software having a dependence relationship with the software is performed.

Although the embodiment has been described above, this is an example for describing the present invention and is not intended to limit the scope of the present invention only to the present embodiment. The present invention can also be implemented in various other forms.

1. A license management system comprising:
a registration unit configured to receive, for a license management unit that is one or a plurality of pieces of software present in one or a plurality of servers and licensed, an input of a budget serving as a threshold value of a license fee, and a budget management period serving as a period in which the budget is applied, and register the received budget and budget management period;
a collection unit configured to collect information on the one or each of the plurality of pieces of software;
a calculation unit configured to calculate, for each point in time, an actual license fee at the point in time on the basis of management information including information collected for the one or each of the plurality of pieces of software, calculate a predicted license fee at the time of the end of the budget management period on the basis of a time series of the actual license fee, and calculate a first optimal software use situation in a case in which the calculated predicted license fee exceeds the budget; and
a control unit configured to perform first software situation control, the first software situation control being control regarding the one or plurality of pieces of software for bringing a software use situation to the first optimal software use situation,
wherein the management information includes
information indicating whether a certain piece of software is present in one or more certain servers, and
type management information, the type management information being information indicating, for each piece of software, a license type, a license purchase unit by type, a fixed license fee regardless of a license period, a license fee per period unit of the license period, and a period unit of the license period,
for each point in time,
the calculated actual license fee is a cumulative value of an actual license fee total up to the point in time, and
the actual license fee total is a total at the point in time of the license fee calculated for each piece of software on the basis of the management information,
the first optimal software use situation is a software use situation in which the predicted license fee is within the budget,
the calculation of the first optimal software use situation includes a determination as to which software of a certain one of the servers is set to a stop target, and
the first software situation control includes stopping the software in the server.

2. The license management system according to claim 1,
wherein the management information includes priority management information, the priority management information being information indicating a priority of each classification element belonging to one or each of a plurality of classifications for the one or each of the plurality of classifications,
the one or plurality of classifications include a classification such as software, and the priority of each classification element belonging to the classification is a priority of the software itself, and
the calculation unit determines which software of a certain one of the servers is set as a stop target on the basis of the priority management information.

3. The license management system according to claim 2,
wherein the plurality of classifications include at least one of a server type of the server in which there is software and an environment in which there is software, and
the calculation unit determines a priority of the software on the basis of a priority of the software itself and a priority of at least one of the server type of the server in which there is the software and the environment in which there is the software.

4. The license management system according to claim 2,
wherein the calculation unit
(a) selects the software with the lowest priority from among the unselected software subjected to stop release, and sets the selected software as a stop candidate,
(b) calculates a predicted license fee in a case in which all the stop candidate pieces of software are stopped during a certain period, and determines whether the predicted license fee is equal to or less than a comparison target budget equal to or less than the budget,
(c) performs (a) when a determination result of (b) is false,
(d) excludes the most pieces of software from the stop candidates in a range in which the predicted license fee is equal to or less than the comparison target budget when the determination result of (b) is true, and
(e) determines all the stop candidate pieces of software after (d) as stop targets.

5. The license management system according to claim 4,
wherein the calculation unit, in (a),
(a1) selects software with the lowest priority from among unselected pieces of software subjected to stop release,
(a2) sets the selected software as the stop candidate when there is no dependence destination software of the selected software, and
(a3) sets the selected software and the dependence destination software thereof as stop candidates when there is the dependence destination software of the selected software.

6. The license management system according to claim 5,
wherein the calculation unit
sets the selected software and the dependence destination software thereof as stop candidates when the priority of the dependence destination software is the next lowest priority after a priority of the selected software in (a3), and
selects software with a priority lower than the priority of the dependence destination software and performs (a2) when there is dependence destination software of the selected software, but there is the software.

7. The license management system according to claim 1,
wherein the calculation unit cyclically performs the calculation of the predicted license fee, and
the cycle of the calculation has the same length as the shortest period unit among period units of the plurality of pieces of software.

8. The license management system according to claim 1,
wherein the calculation unit presents the first optimal software use situation to a manager, and
when approval for the presented first optimal software use situation is received from the manager, the control unit performs the first software situation control.

9. The license management system according to claim 1,
wherein the calculation unit calculates a second optimal software use situation in a case in which the calculated predicted license fee is within the budget and a difference between the predicted license fee and the budget is equal to or greater than a certain value,
the control unit performs second software situation control, the second software situation control being control regarding the one or plurality of pieces of software for bringing the software use situation to the second optimal software use situation,
the second optimal software use situation is a software use situation in which the predicted license fee approaches the budget,
the calculation of the second optimal software use situation includes a determination of stopping of which software of a certain one of the servers is to be released, and
the second software situation control includes stop release of the software in the server.

10. A license management method comprising:
receiving, by a computer, for a license management unit that is one or a plurality of pieces of software present in one or a plurality of servers and licensed, an input of a budget serving as a threshold value of a license fee, and a budget management period serving as a period in which the budget is applied;
collecting, by the computer, information on the one or each of the plurality of pieces of software;
calculating, by the computer, for each point in time, an actual license fee at the point in time on the basis of management information including information collected for the one or each of the plurality of pieces of software, calculating a predicted license fee at the time of the end of the budget management period on the basis of a time series of the actual license fee, and calculating an optimal software use situation in a case in which the calculated predicted license fee exceeds the budget; and
performing, by the computer, software situation control, the software situation control being control regarding the one or plurality of pieces of software for bringing a software use situation to the optimal software use situation,
wherein the management information includes
information indicating whether a certain piece of software is present in one or more certain servers, and
type management information, the type management information being information indicating, for each piece of software, a license type, a license purchase unit by type, a fixed license fee regardless of a license period, a license fee per period unit of the license period, and a period unit of the license period,
for each point in time,
the calculated actual license fee is a cumulative value of a license fee total up to the point in time,
the actual license fee total is a total at the point in time of the license fee calculated for each piece of software on the basis of the management information,
the optimal software use situation is a software use situation in which the predicted license fee is within the budget,
the calculation of the optimal software use situation includes a determination as to which software of a certain one of the servers is set to a stop target, and
the software situation control includes stopping the software in the server.
